(19) United States
(12) Patent Application Publication
(10) Pub. No.: US 2015/0036835 A1
(43) Pub. Date: Feb. 5, 2015

(54) EARPIECES WITH GESTURE CONTROL

(71) Applicant: Christina Summer Chen, Bellevue, WA (US)

(72) Inventor: Christina Summer Chen, Bellevue, WA (US)

(21) Appl. No.: 13/959,109

(22) Filed: Aug. 5, 2013

(51) Int. Cl. H04R 1/10

(52) U.S. Cl. CPC H04R 1/1041; H04R 25/554
USPC 381/74

(57) ABSTRACT

Many types of earpiece devices are available for various scenarios, such as hearing aids and headphones. However, many types of earpieces exhibit various disadvantages relating to the discretion, privacy, and/or security. For example, some earpieces are observable when worn by the user (e.g., over-head and over-ear headphones); some earpieces play sound that is audible to other users; and some earpieces enable interaction with second devices (e.g., mobile phones) through overt interaction a physical control, such as manually pressing a button on the earpiece. Presented herein are earpieces that rest within an ear canal and selectively transmit audio through a speaker into the ear canal while reducing obstruction of ambient sound, and that enable interaction with second devices through gestures, such as nodding or tilting the head, rather than overt physical interactions. These and other design considerations may facilitate discreet use of the device and the privacy of the user.

### BACKGROUND

Within the field of computing, many scenarios involve an earpiece device that produces audio for a user. As a first example, a hearing aid may be positioned within an ear or ear canal of a user, and may amplify and/or filter ambient audio in order to overcome a hearing deficiency of the user. As a second example, a pair of headphones may communicate, through a wired or wireless protocol, with a second device such as a computer, portable media player, or mobile phone in order to transmit audio to the user. Some such earpieces may also feature a button or switch that, when manually activated by the user, adjusts various properties of the earpiece, such as volume, and/or communicates with the second device, such as accepting an incoming call from a mobile phone or skipping to a next track in a playlist of a portable media player.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among the range of current earpieces, it may be appreciated that several disadvantages may arise in relation to the visibility and functionality of the earpiece device. As a first example, many earpieces are large and readily visible pieces of equipment, such as those that cover the ear or head, or that rest on an outer portion of the ear. Additionally, interaction with the device may involve an overt action, such as pressing a physical button or toggling a physical switch on the earpiece or a wire connected thereto, or manipulating the second device. In some such earpieces, the physical design and/or volume level of the earpiece results in sound that is audible to individuals other than the individual wearing the earpiece, and/or may obstruct ambient sound, such as earpieces that cover the ear and muffle ambient sound, or that broadcast over the ambient sound. However, some users may not wish to wear such readily visible devices, and may prefer earpieces that are more discreet (e.g., those that rest behind the ear); that produce audio that is audible only to the user, without obstructing ambient sound (e.g., featuring a directional speaker that selectively directs sound into the ear canal, while not fully blocking the ear canal); and/or that permit less overt interactions (e.g., earpieces that are receptive to gestures, such as a nod or tilt of the head, rather than manual interaction with a physical control of the earpiece). Such discretion may be desired, e.g., to reduce the overt appearance of the interaction of the user with a device during a social event; to promote privacy; and/or to avoid attracting notice to the user's device as a safety precaution. As a second example, many earpieces provide little or no interaction with the second device; e.g., the physical controls of an earpiece connectible with a cellular phone may be limited to accepting an incoming call and adjusting volume. However, earpieces that accept commands via gestures may provide a fuller degree of interactive capabilities, and may even provide functionality for the earpiece apart from the second device (e.g., enabling the invocation and execution of audio-only applications on the earpiece).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring examples of earpiece devices usable in various contexts.

FIG. 2 is an illustration of an exemplary scenario featuring an earpiece device that is responsive to physical gestures for interaction with a second device in accordance with the techniques presented herein.

FIG. 3 is an illustration of an exemplary scenario featuring an earpiece set of earpiece devices that interoperate to provide interaction with a second device in accordance with the techniques presented herein.

FIG. 4 is a flow diagram of an exemplary method of configuring an earpiece to communicate with a second device in accordance with the techniques presented herein.

FIG. 5 is an illustration of an exemplary computer-readable storage medium storing instructions that, when executed on a processor of a device, cause the device to operate in accordance with the techniques presented herein.

FIG. 6 is an illustration of an exemplary scenario featuring an inertial measurement unit of an earpiece that is responsive to a gesture in accordance with the techniques presented herein.

FIG. 7 is an illustration of an exemplary scenario featuring the presentation of a reminder by an earpiece during an opportunity in accordance with the techniques presented herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

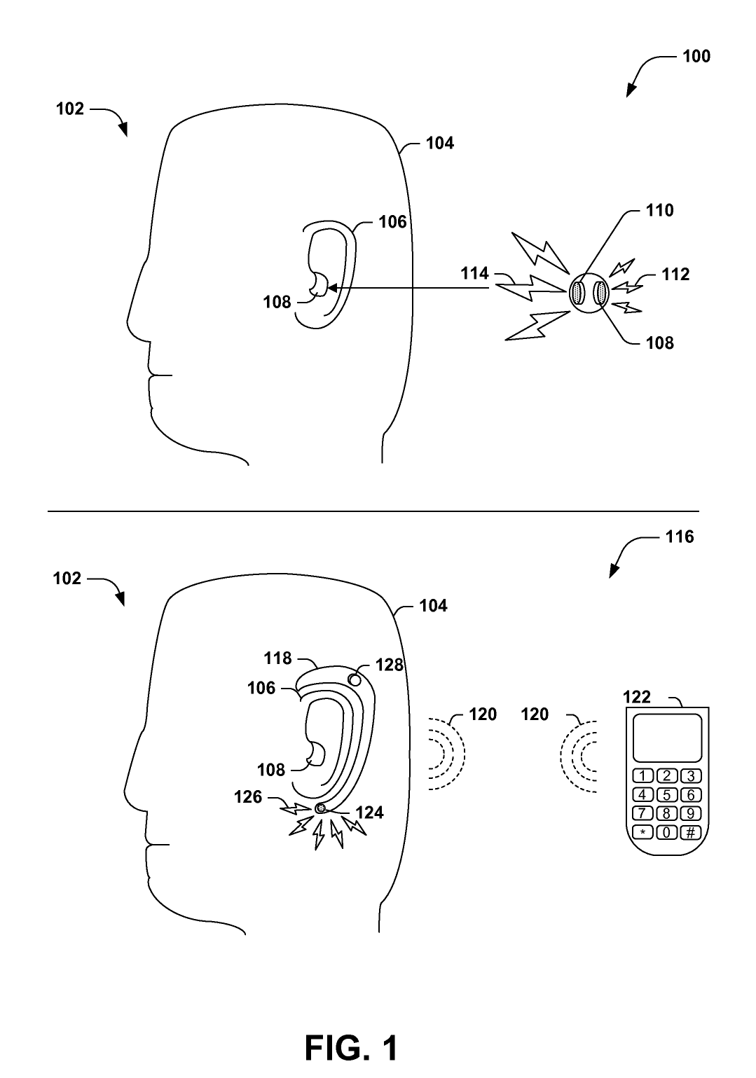

FIG. 1 presents illustrations of example earpieces that are usable in various contexts. As a first example 100, a user 102 may position a hearing aid within an ear canal 108 of an ear 106 of the head 104 of the user 102. The hearing aid may be designed with a small size fitting within the ear canal 108 for discretion, and may comprise a microphone receiving ambient sound 112 from within the environment, and a speaker 110 that broadcasts amplified sound 114 into the ear canal 108 of the user 102. Such hearing aids may discreetly facilitate the hearing of the user 102, but typically feature limited or no interactive capabilities, and may not communicate with any other device. As a second example 116, an earpiece 118 may communicate through a wireless connection 120 with a second device 122, such as a mobile phone, in order to transmit audio to the user 102 originating near the ear 106 of the user 102 rather than from the second device 122, which may be in the user's hand, pocket, or purse, or may not even be currently carried by the user 102. This earpiece 118 features a speaker 124 positioned near the bottom of the ear 106 of the user 102, such that ambient sound 112 broadcast by the speaker 124 may reach the ear canal 108 of the user 102. This earpiece 118 also features a mechanical control 128, in the form of a button that the user 102 may manually depress to accept a call from the second device 122.

While the earpieces illustrated in FIG. 1 may present various advantages, some disadvantages may also arise from the use of such earpieces. As a first example, a selection of earpieces devices may exhibit a tradeoff between size and functionality. A small hearing aid may be discreetly worn in the ear and may not be noticeable to individuals other than the user 102, but may offer limited functionality and no interaction with a second device 122. On the other hand, more full-featured earpiece 118 often enable interaction with a second device 122, but tend to be much larger and readily noticeable by other individuals, and to enable interactions with the second device 122 through overt actions with mechanical controls 128, such as physically depressing the button on the earpiece 118. Such actions may call attention to the user 102 of the earpiece 118, which may be socially undesirable (e.g., wearing and using the earpiece 118 in a group meeting or at a social engagement), and/or may present a security risk. As a second example, the volume level of audio transmitted by such devices may be difficult to balance against the ambient sound 112 of the environment of the user 102. For example, the in-ear hearing aid may amplify ambient sound 112 while in use, but may physically obstruct the ear canal 108 of the user 102, and may significantly block ambient sound 112 when not in use. By contrast, an earpiece 118 with a speaker 124 positioned near the bottom of the ear 106 may not block ambient sound 112, but may transmit audio output 126 that is audible to individuals other than the user 102. As a third example, the interaction of such earpieces with a second device 122, such as a mobile phone having a wireless connection 120 with the earpiece 118, may be limited to the functions accessible through mechanical controls 128; e.g., the earpiece 118 in the second example 116 may enable the user 102 to accept an incoming call from the mobile phone and/or to disconnect the call by depressing the button, but may not enable any other commands to be sent from the earpiece 118 to the mobile phone due to the absence of other mechanical controls. These and other disadvantages may arise with earpieces such as depicted in the examples of Fig.

### B. Presented Techniques

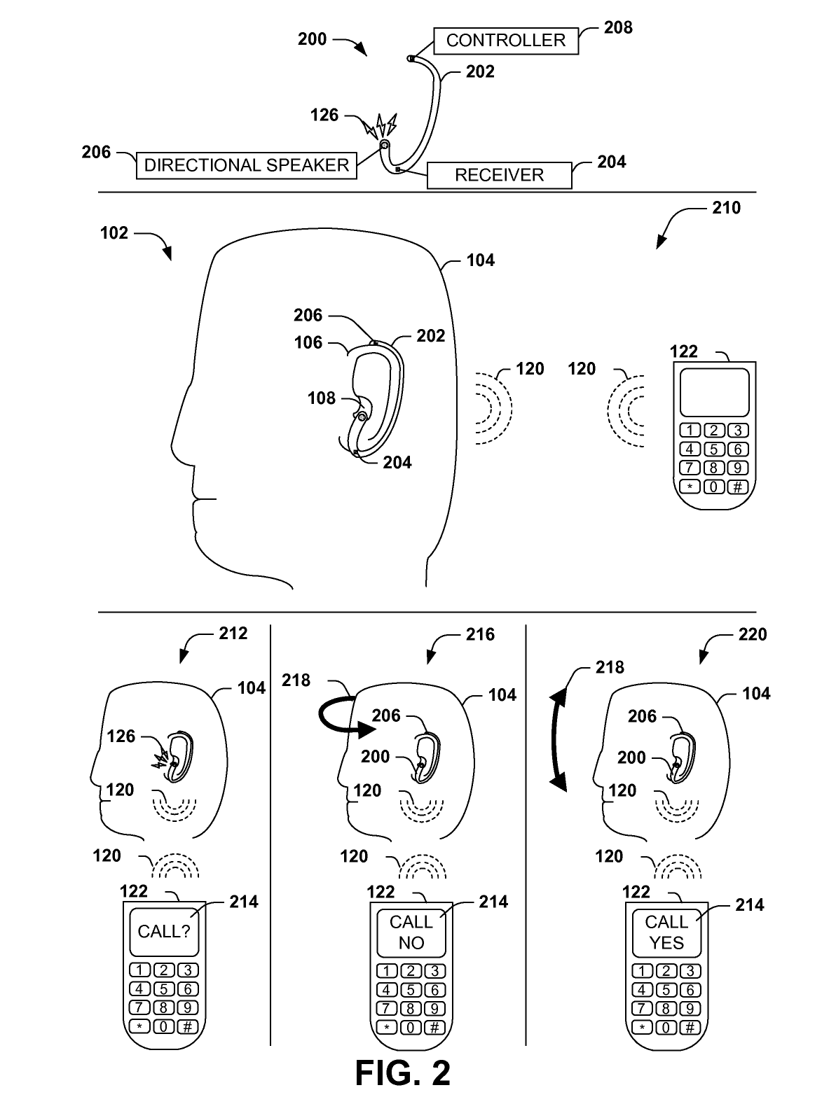

FIG. 2 presents an illustration of an exemplary scenario featuring an earpiece 200 usable by a user 102 with a second device 122 in accordance with the techniques presented herein. In this example, the earpiece 200 features a housing 202 that is mountable on an ear 106 of the user 102. The earpiece 200 also features a receiver 204 that couples wirelessly with the second device 122 to receive audio output from the second device 122. The earpiece 200 also features a directional speaker 206 that is positioned on the housing 202 such that, when the housing 202 is mounted on the ear 106 of the user 102, transmits the audio output selectively into the ear canal 108 of the user 102; and a controller 208 incorporated in the housing 202 that, when upon detecting a gesture by the user 102, alters the audio output 126 of the directional speaker 206 (e.g., adjusting the volume of the earpiece 200; accepting or refusing a call received by a mobile phone; or playing, stopping, or changing the audio output 126 presented to the user 102 through the directional speaker 206).

As further illustrated in an exemplary diagram 210 of FIG. 2, the earpiece 200 is mountable on an ear 106 of the user 102 in a more discreet manner than other earpieces; e.g., the earpiece 200 is tucked behind the ear 106 of the user 102 and, optionally, behind the hair of the user 102 near the ear 106, such that the earpiece 200 may only be visible to other individuals through the portion containing the directional speaker 206 positioned near the ear canal 108. This discreet presentation may reduce the attention drawn to the user 102 wearing the earpiece 200. Additionally, the positioning of the directional speaker 206 to selectively direct the audio output 126 into the ear canal 108 of the user 102, but without entering or blocking the ear canal 108 of the user 102, may enable the presentation of audio output 126 that is audible to the user 102 but not easily audible to other individuals, while also not blocking ambient sound 112 while not in use.

As further illustrated in FIG. 2, the inclusion of the controller 208 may facilitate interaction of the user 102 with the second device 122 through the earpiece 200. For example, at a first time point 212, a second device 122 such as a mobile phone may receive a call 214, and may transmit a notification of the call 214 through the wireless connection 120 to the earpiece 200, which may activate the directional speaker 206 to play audio output 126 for the user 102 as a notification cue of the call 214. At a second time point 216, if the user 102 performs a gesture 218 indicating a refusal of the call 214, such as laterally shaking the head 104, the controller 208 may detect the gesture 218 and send a signal back to the second device 122 over the wireless connection 120 to decline the call 214. Alternatively, at a third time point 220, the user 102 may initiate a second gesture 218 indicating an acceptance of the call 214, such as nodding his or her head 104; accordingly, the controller 208 of the earpiece 200 may detect the gesture 218, and the receiver 204 may transmit a signal to the second device 122 to accept the call 214, which may transmit the audio of the call 214 to the earpiece 200 for presentation to the user 102. In this manner, the earpiece 200 may enable interaction with the second device 122 through gestures 218 that may be more subtle than physical interaction with mechanical components of the earpiece 200. Additionally, the controller 208 may enable a wider and more natural range of gestures 218 than a mechanical control 128 such as a button. These and other advantages may be achievable in embodiments of earpieces 200 according to the techniques presented herein.

### C. Exemplary Embodiments

FIG. 2 presents a first exemplary embodiment of the techniques presented herein, illustrated as an exemplary earpiece 200 wearable by a user 102 and usable with a second device 122 of the user 102. The exemplary earpiece 200 comprises a housing 202 that is mountable on an ear 106 of the user 102; a receiver 204 that couples wirelessly with the second device 122 to receive audio output 126 from the second device 122; a directional speaker 206 positioned on the housing that, when the housing is mounted on the ear of the user, transmits the audio output 126 selectively into the ear canal 108 of the user 102; and a controller 208 incorporated in the housing 202 that, when upon detecting a gesture 218 by the user 102, alters the audio output 126 of the directional speaker 206. As another description, the exemplary scenario of FIG. 2 illustrates an earpiece 200 wearable by a user 102 and usable with a second device 122 of the user 102, the earpiece 200 comprising a housing 202 mountable on an ear 106 of the user 102 and comprising a directional speaker 206 selectively oriented toward an ear canal 108 of the user 102; a receiver 204 that receives audio output 126 from the second device 122 through a wireless protocol, and conducts the audio output 126 received from the second device 122 to the directional speaker 206; and a controller 208 that, when upon detecting a gesture 218 by the user 102, alters the audio output 126 of the directional speaker 206.

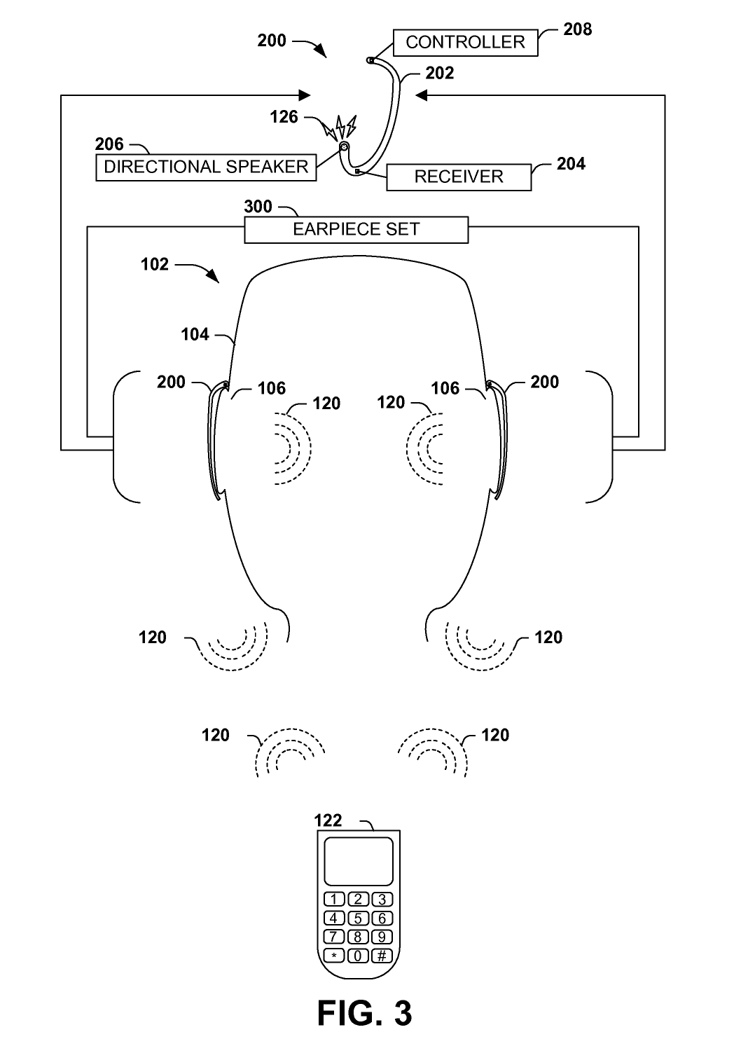

FIG. 3 presents an illustration of a second embodiment of the techniques presented herein, illustrated as an earpiece set 300 comprising a pair of earpieces 200 respectively wearable in the left and right ears 106 of a user 102. The earpiece set 300 comprises at least two housings 202 respectively mountable on an ear 106 of the user 102, where each housing 202 comprises a directional speaker 206 that, when the housing 202 is mounted on the ear 106 of the user 102, selectively transmits audio output 126 toward the ear canal 108 of the user 102. The earpiece set 300 also comprises, for at least one housing 202 of at least one earpiece 200, a receiver 204 that couples wirelessly with the second device 122 to receive audio output 126 from the second device 122 and directs the audio output 126 to the directional speaker 206 of at least one earpiece 200 (e.g., either one receiver 204 may be shared by the earpieces 200, or each earpiece 200 may comprise a receiver 204). The earpiece set 300 also comprises, for at least one housing 202, a controller 208 incorporated in the housing 202 that, upon detecting a gesture 218 by the user 102, alters the audio output 126 of the directional speaker 206 (e.g., adjusting the volume; accepting, declining, or terminating the audio output 126 of a call 214 received by a mobile phone; or changing media in an audio stream of the second device 122).

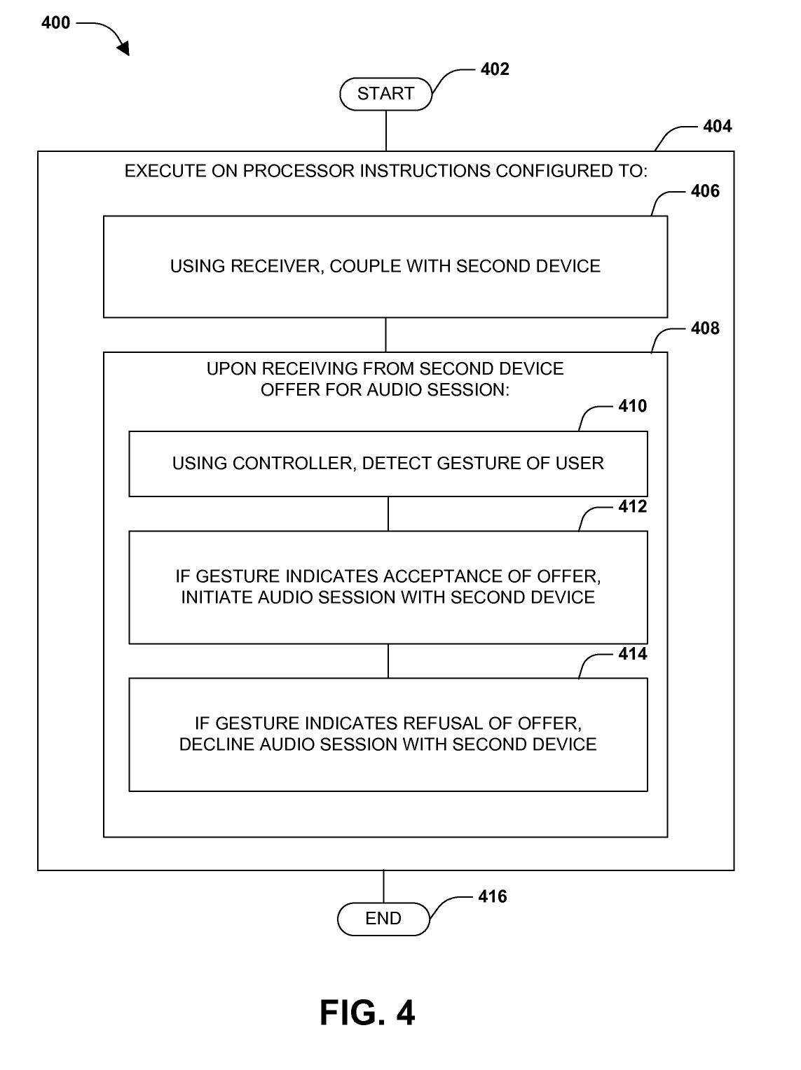

FIG. 4 presents an illustration of a third exemplary embodiment of the techniques presented herein, illustrated as an exemplary method 400 of configuring an earpiece 200 wearable by a user 102 to communicate with a second device 122 of the user 102, where the earpiece 200 comprises a receiver 204, a directional speaker 206, and a controller 208. The exemplary method 400 may be implemented, e.g., as a set of instructions stored in a memory component of the earpiece 200, such as a memory circuit, a platter of a hard disk drive, a solid-state storage device, or a magnetic or optical disc, and organized such that, when executed on a processor of the earpiece 200, cause the earpiece 200 to operate according to the techniques presented herein. The exemplary method 400 begins at 402 and involves executing 404 the instructions on a processor of the earpiece 200. Specifically, the instructions are configured to, using the receiver 204, couple 406 with the second device 122. The instructions are further configured to, upon receiving 408 from the second device 122 an offer to initiate an audio session, using the controller 208, detect 410 a gesture 218 of the user 102. The instructions are further configured to, upon detecting a gesture 218 indicating acceptance of the offer, initiate 412 the audio session with the second device 122; and, upon detecting a gesture 218 indicating a refusal of the offer, decline 414 the audio session with the second device 122. In this manner, the instructions of the exemplary method 400 of FIG. 4 enable the earpiece 200 to communicate with the second device 122 of the user 102 in accordance with the techniques presented herein, and so ends at 416.

Still another embodiment involves a computer-readable medium comprising processor-executable instructions configured to apply the techniques presented herein. Such computer-readable media may include, e.g., computer-readable storage devices involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage devices) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

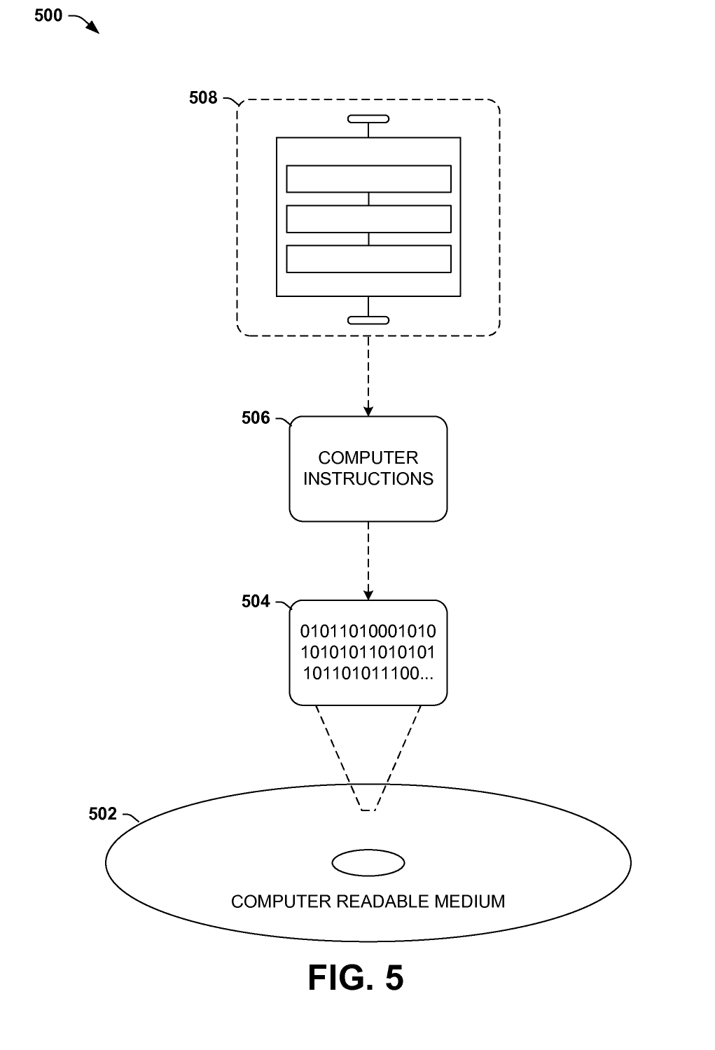

An exemplary computer-readable medium that may be devised in these ways is illustrated in FIG. 5, wherein the implementation 500 comprises a computer-readable storage device 502 (e.g., a CD-R, DVD-R, or a platter of a hard disk drive), on which is encoded computer-readable data 504. This computer-readable data 504 in turn comprises a set of computer instructions 506 configured to operate according to the principles set forth herein. In one such embodiment, the processor-executable instructions 506 may be configured to perform a method of enabling an earpiece 200 to communicate with a second device 122 on behalf of a user 102, such as the exemplary method 400 of FIG. 4. Some embodiments of this computer-readable medium may comprise a computer-readable storage device (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary earpiece 200 of FIG. 2; the exemplary earpiece set 300 of FIG. 3; the exemplary method 400 of FIG. 4; and the exemplary computer-readable storage device of FIG. 5) to confer individual and/or synergistic advantages upon such embodiments.

### D1. Scenarios

A first aspect that may vary among embodiments of these techniques relates to the scenarios wherein such techniques may be utilized.

As a first variation of this first aspect, the techniques presented herein may be utilized with many types of earpieces 200 presenting many types of audio output 126 from many types of second devices 122. For example, the earpieces 200 may comprise headsets for computers, televisions, or portable devices such as mobile phones, mobile media players, and mobile game devices; navigation devices for use with a vehicle; and the earpiece components of wearable headsets. Additionally, the receiver 204 of the earpiece 200 may communicate with the second device 122 in various ways, such as a persistent wired connection between the earpiece 200 and the second device 122 (e.g., a mobile phone work elsewhere on the body of the user 102); a transient wired connection between the earpiece 200 and the second device 122 (e.g., a connectible cable, such as a Universal Serial Bus (USB) cable); a directed wireless connection according to a wireless protocol; or a broadcast wireless connection, such as a radio frequency broadcast by the second device 122 to any nearby devices. Further, the connection between the earpiece 200 and the second device 122 may be comparatively persistent, or may be transient; e.g., the earpiece 200 and the second device 122 may interact and exchange data comprising audio output 126 while connected, such that the earpiece 200 may continue to present the audio output 126 of the second device 122 while disconnected.

As a second variation of this first aspect, an earpiece 200 configured as presented herein may be worn on an ear 106 of a user 102 in many ways, such as clipping to the helix of the outer ear; having an overlapping cover that fits over the antihelical fold of the outer ear; or attaching to the head 104 of the user 102 behind the ear 106. A portion of the earpiece 200 positioned near the ear canal 108 of the user 102 may be partially held in place and/or concealed by tragus of the ear 106. The portion of the housing 202 of the earpiece 200 comprising the directional speaker 206 may enter the ear canal 108 of the ear 106 of the user 102; may be positioned near the ear canal 108 of the ear 106 of the user 102; and/or may be positioned within line of sight of the ear canal 108, while using focused audio techniques to direct the audio output 126 selectively toward the ear canal 108. It may be advantageous to design the housing 202 of the earpiece 200 not to obstruct ambient sound 112 arising within an environment of the user 102.

As a third variation of this first aspect, the earpiece 200 may interact with one ear 106 of the user 102, or with both ears 106 of the user 102 (e.g., the housing 200 may extend between the ears 106, and may include a directional speaker 206 for each ear 106). Alternatively, as illustrated in the exemplary earpiece set 300 of FIG. 3, a first earpiece 200 worn on one ear 106 may connect through a wired or wireless connection with a second earpiece 200 worn on the other ear 106 of the user 102, and may interoperate with the second earpiece 200 to achieve the presentation of the audio output 126 from the device 122 to both ears 106 of the user 102. As one such example, where respective housings 200 further comprise a battery, the controller 208 may selectively activate the directional speaker 206 of a first earpiece 200, and deactivate the directional speaker 206 of the second earpiece 200, in order to conserve battery power (e.g., alternating between the earpieces 200 throughout the day). Many such variations may be devised in embodiments of the techniques presented herein.

### D2. Controller and Gestures

A second aspect that may vary among embodiments of the techniques presented herein relates to the control of the audio output 126 of the directional speaker 206 by the controller 208, including the detection of gestures 218 performed by the user 102 for controlling such audio output 126.

As a first variation of this second aspect, many types of gestures 218 may be detected for responsive adjustment of the audio output 126 of the earpiece 200. As noted herein, it may be advantageous to select a controller 208 that does not involve a mechanical control 128 that responds to manual manipulation, such as a button-press, as gestures may draw less attention to the user 102 and the interaction with the earpiece 200.

As a first such example, the controller 208 may comprise an accelerometer, and the gesture detected by the controller 208 may comprising a tap of the housing 202 by the user 102 that is detected by the accelerometer. That is, rather than utilizing a button that the user 102 manually locates and depresses with a fingertip, the earpiece 200 may be sensitive to a single tap anywhere on or near the earpiece 200 or ear 106 of the user 102, thus enabling control of the audio output 126 through a less over gesture 218.

As a second such example, the controller 208 may comprise an inertial measurement unit, and the gesture 218 detected by the controller 208 may comprise an inertial head gesture of the head 104 of the user 102, such as nodding the head to indicate acceptance of the audio output 126 of the second device 122.

As a third such example, the gesture 218 may comprise a spoken keyword or phrase, and the controller 208 may comprise a voice monitoring component that monitors the voice of the user 102 to detect the spoken keyword or phrase, optionally with a particular tone or volume.

As a second variation of this second aspect, the controller 208 of the earpiece 200 may be configured to recognize a variety of gestures 218. As a first example of this second variation of this second aspect, the controller 208 may detects a first inertial gesture of the user 102 indicating the gesture 218 by the user 102 in a first context, and a second inertial gesture of the user 102 indicating the same gesture 218 by the user 102 in a second context. For example, in loud environments featuring a high volume of ambient sound 112, the controller 208 may detect inertial gestures 218 such as a nod or tilt of the head; but in quiet environments featuring a low volume of ambient sound 112, the controller 208 may detect voice gestures 218 such as spoken keywords. Such alternative gestures 218 may be detected in a mutually exclusive manner, or in an alternative manner (e.g., the user 102 may perform either gesture 218 in a particular context to achieve the desired result).

As a second example of this second variation of this second aspect, the controller 208 may be capable of detecting a first gesture 218 associated with a first adjustment of the output of the directional speaker 206 (e.g., accepting a call, increasing a volume level, or sending a first command to the second device 122), and also a second gesture 218 associated with a second adjustment of the output of the directional speaker 206 (e.g., declining a call, decreasing a volume level, or sending a second command to the second device 122). These and other variations in the detection of gestures 218 may be implemented in variations of the techniques presented herein.

### D3. Battery Conservation

A third aspect that may vary among embodiments of these techniques involves configuration of the operation of the earpiece 200 in a manner that may conserve and expand the battery power and life of the earpiece 200.

As a first variation of this third aspect, in the example of gestures 218 comprising spoken keywords or phrases, the earpiece 200 may continuously record ambient sound 112 in the environment of the user 102, but the controller 208 may not continuously evaluate the audio to determine whether the user 102 has spoken the keywords or phrases. Rather, the earpiece 200 may continuously evaluate the ambient sound 112 less thoroughly, e.g., to detect sound in the frequency range of human voice and for a duration matching the duration of the spoken keyword or phrase, and may then activate the controller 208 to perform a more thorough evaluation of the stored ambient sound 112 to detect the keywords within the recorded audio. By applying a more thorough and computationally intensive evaluation only when a less thorough evaluation determines that a gesture 218 may have been performed, this variation may enable a conservation of computing resources and the extension of the battery life of the earpiece 200.

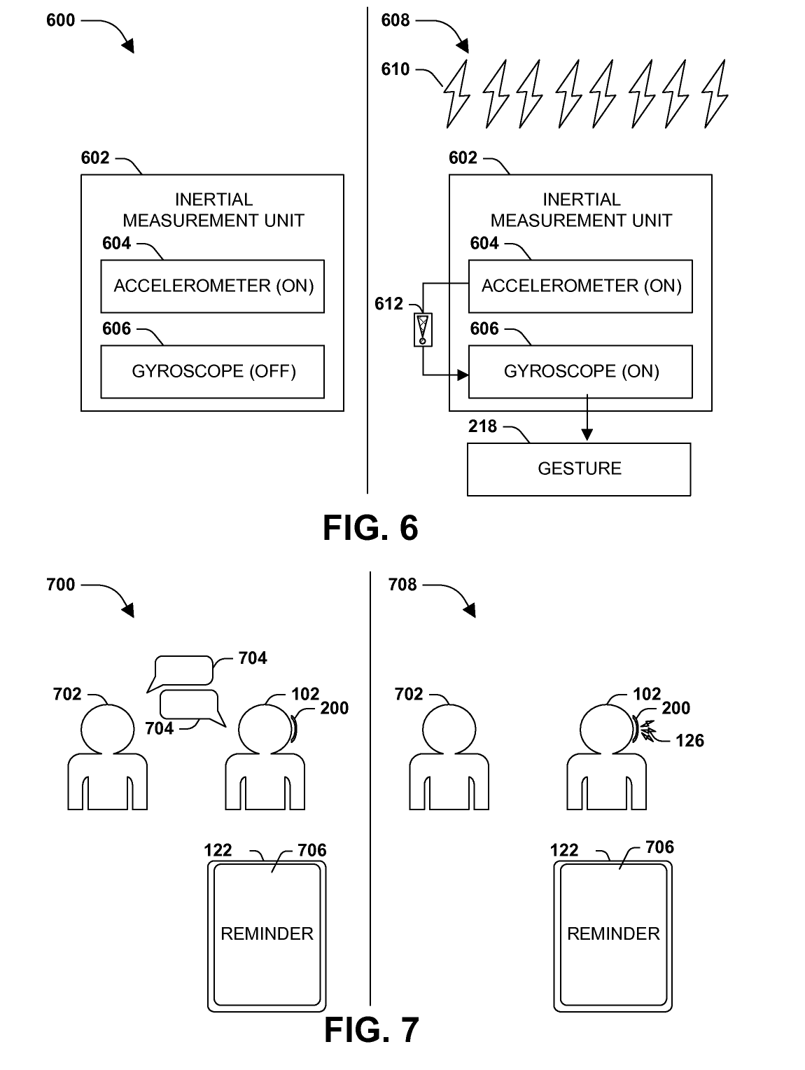

FIG. 6 presents an illustration of a second variation of this third aspect that may be incorporated in the design of an inertial measurement unit 602 configured to detect a gesture 218 performed with the head 104 of the user 102 (e.g., nodding the head 104 as a gesture 218 indicating the acceptance of the audio output 126 of the second device 122). In this example, the inertial measurement unit 602 comprises an accelerometer 604 that detects an acceleration of the head 104 of the user 102 that may represent an inertial head gesture, and a gyroscope 606 that more specifically determines whether the acceleration of the head 104 actually does represent the inertial head gesture. That is, the accelerometer 604 detects only that the head 104 of the user 102 is moving in a manner that may be associated with a gesture 218, and the gyroscope 606 more particularly evaluates the movement of the head 104 to determine that the gesture 218 has been performed (and, in some embodiments, the recognition of a particular gesture 218 among several recognized gestures 218), as well as determinations such as distinguishing false positives and false negatives. Because the evaluation performed by the gyroscope 606 may involve the capturing of more sensitive data and/or a more computationally intensive evaluation, it may be not be desirable to utilize the gyroscope 606 continuously. Rather, at a first time point 600, the accelerometer 604 of the inertial measurement unit 602 may be activated to monitor the acceleration of the head 104, and the gyroscope 606 may be disabled while no such acceleration is detected. At a second time point 608, the accelerometer 604 may detect such acceleration 610, and may activate 612 the gyroscope 606 to more particularly evaluate the acceleration 610 to identify the inertial head gesture 218 of the head 104 of the user 102. After recognizing the gesture 218, failing to recognize the gesture 218, or detecting a cessation of the acceleration 610 of the head 104, the gyroscope 606 may be deactivated until a second instance of the acceleration 610 is detected. In this manner, the earpiece 200 may conserve the computational resources of the gesture evaluation, e.g., in order to expand the battery life of the earpiece 200. Many such adjustments of the functionality of the earpiece 200 may be selected in furtherance of the battery capacity and life of the earpiece 200 in accordance with the techniques presented herein.

### D4. Audio Sessions

A fourth aspect that may vary among embodiments of the techniques presented herein relates to audio session offered the second device 122 for presentation by the earpiece 200.

As a first variation of this fourth aspect, a mobile phone may receive an incoming call, and may offer to the earpiece 200 the opportunity to engage in an audio session comprising the call; or a media player may receive an audio stream, and may present to the earpiece 200 an offer to stream the audio output 126 to the user. In such scenarios, the gesture 218 detected by the controller 208 may pertain to the audio session. For example, the gestures 218 detected by the controller 208 may indicate the acceptance or refusal of the audio session in various ways. For example, in a default decline configuration, where no gesture indicates a refusal of the audio session, the controller 208 may alter the audio output 126 of the directional speaker 206 by, upon failing to detect a gesture 218 by the user 102 that is associated with the acceptance of the audio session, blocking the transmitting of the audio output of the audio session (e.g., simply not playing the audio output 126 of the audio session provided by the second device 122, or actively notifying the second device 122 not to accept or transmit the audio session). Conversely, upon detecting a gesture by the user 102 associated with the audio session, the controller 208 may permit the transmitting of the audio output 126 of the audio session for presentation by the directional speaker 206. As a second example, upon detecting a gesture 218 by the user 102 that is associated with a refusal of the audio session, the controller 208 may block the transmitting of the audio output 126 of the audio session. In an embodiment, the acceptance gesture comprises a first gesture, and the refusal gesture comprises a second gesture that is different from the first gesture (e.g., the controller 208 may detect both nodding the head 104 of the user 102 to accept a call, and shaking the head 104 of the user 102 to refuse a call).

As a second variation of this fourth aspect, an earpiece 200 may transmit to the user 102 an offer of the audio session from the second device 122. For example, the second device 122 may notify the earpiece 200 of an incoming call, and the earpiece 200 may play an audial cue for the user 102 to indicate the incoming call. Additionally, in an embodiment, controller 208 detects the gestures 218 of the user 102 only in response to transmitting the output to the user 102 indicating the offer; e.g., an earpiece 200 for a mobile phone may not continuously monitor the inertial head gestures of the user 102, but may only do so after presenting to the user 102 an offer to accept an incoming call from the mobile phone, thus conserving and expanding the battery power of the earpiece 200. Many such variations in the acceptance of refusal of audio sessions with the second device 122 may be included in earpieces 200 operating in accordance with the techniques presented herein.

### D5. Environmental Adjustments

A fifth aspect that may vary among embodiments of the techniques presented herein relates to the adaptation of the earpiece 200 to the environment of the user 102.

As a first variation of this fifth aspect, an earpiece 200 may adapt the volume of the directional speaker 206 in response to the environment, and may adjust the volume level of the audio output 126 of the directional speaker 206 proportionally with the volume of the ambient sound of the environment of the user 102 (e.g., automatically increasing the volume of the directional speaker 206 in noisy environments, and reducing the volume of the directional speaker 206 in quiet environments).

As a second variation of this fifth aspect, an earpiece 200 may select the volume of the directional speaker 206 in furtherance of the privacy of the user 102. For example, the controller 208 may selects a volume level of the audio output 126 of the directional speaker 206 that is substantially inaudible outside of the ear canal 108 of the user 102 to other individuals who may be present in the environment of the user 102.

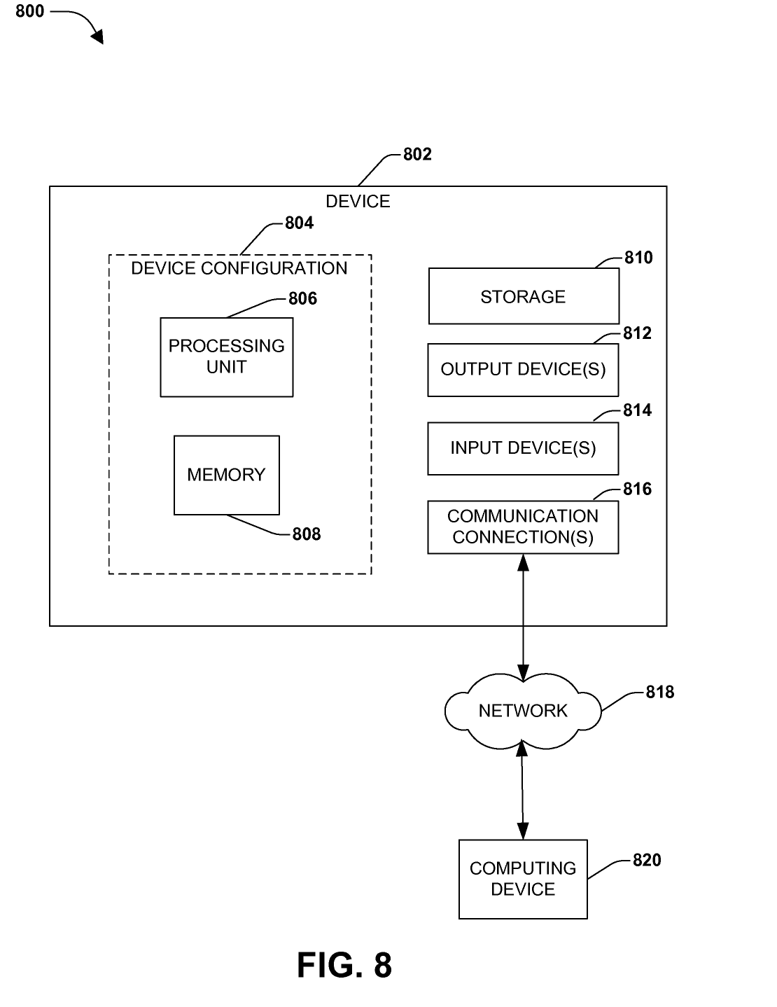

FIG. 7 presents an illustration of a third variation of this fifth aspect, wherein an earpiece 200 evaluates the environment of the user 102 in order to detect an offer opportunity to present an offer of an audio session to the user 102. In this exemplary scenario, at a first time point 700, a second device 122 initiates an offer for an audio session 706, and the earpiece 200 receives the offer for presentation to the user 102. However, at the first time point 700, the earpiece 200 may detect that the user 102 is in a conversation 704 with another individual 702, and that the offer for the audio session 706 is not time-sensitive (e.g., simply a reminder of an upcoming appointment), and may forgo presenting an audio cue to the user 102 at the first time point 700. At a second time point 708, the earpiece 200 may detect that the conversation 704 has ended, may infer the end of the conversation 704 as an offer opportunity to present the audio output 126 to the user 102, and may therefore transmit audio output 126 to the user 102 as a cue of the audio session 706 offered by the second device 122. In an embodiment, the earpiece 200 and/or second device 122 may be capable of distinguishing time-sensitive audio sessions (e.g., urgent reminders or incoming calls) from non-time-sensitive audio sessions 706 (e.g., non-urgent reminders or an incoming text message), and may promptly notify the user 102 of time-sensitive audio sessions 706 but may hold non-time-sensitive audio output 126 during conversations 704 (e.g., pausing the playing of a media stream while the user 102 is in a conversation 704 with another individual 702, and resuming the playing of the media stream ten seconds after the end of the conversation 704).

As a third variation of this fifth aspect, an earpiece 200 may adapt to and notify the user 102 of varying connectivity of the earpiece 200 with the second device 122. For example, upon detecting an interruption of the wireless communication session with the second device, the earpiece transmits output to the user indicating the interruption of the wireless communication session. These and other variations of the adaptation of the earpiece 200 to the environment of the user 102 may be included in embodiments of the techniques presented herein.

### D6. Earpiece Applications

A sixth aspect that may vary among embodiments of the techniques presented herein relates to applications that may be executed on the earpiece 200 apart from the second device 122. For example, one or more gestures 218 may be associated with invoking functionality on the earpiece 200 that is not directly associated with audio output 126 generated by the second device 122. For example, an earpiece 200 may further comprise a processor, and at least one application respectively associated with an application gesture and executable on the processor. Upon detecting an application gesture by the user 102, the earpiece 200 may initiate the application associated with the application gesture on the processor. For example, the earpiece 200 may enable playing media stored in a memory of the earpiece 200, and/or a simple game involving audio output 126 and controlled by an inertial head gesture of the user 102, such as an interactive story or a reaction-based game, and the gestures 218 detected by the controller 208 may enable the selection and control of such applications on the device.

### E. Computing Environment

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer-readable storage devices. Such computer-readable storage devices may be volatile and/or nonvolatile, removable and/or non-removable, and may involve various types of physical devices storing computer readable instructions or other data. Memory 808 and storage 810 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. An earpiece wearable by a user and usable with a second device of the user, the earpiece comprising:
a housing mountable on an ear of the user;
a receiver that couples wirelessly with the second device to receive audio output from the second device;
a directional speaker positioned on the housing that, when the housing is mounted on the ear of the user, transmits the audio output selectively into the ear canal; and
a controller incorporated in the housing that, when upon detecting a gesture by the user, alters the audio output of the directional speaker.

2. The earpiece of claim 1, wherein:
the controller comprises an accelerometer; and
the gesture detected by the controller comprising a tap of the housing by the user detected by the accelerometer.

3. The earpiece of claim 1, wherein:
the controller comprising an inertial measurement unit; and
the gesture detected by the controller comprising an inertial head gesture of the user.

4. The earpiece of claim 3, wherein the inertial measurement unit further comprises:
an accelerometer that detects an acceleration of a head of the user; and
a gyroscope activated upon the accelerometer detecting the acceleration of the head of the user, wherein the gyroscope detects the inertial head gesture of the user.

5. The earpiece of claim 3, wherein the inertial measurement unit:
detects a first inertial gesture of the user indicating the gesture by the user in a first context; and
detects a second inertial gesture of the user indicating the gesture by the user in a second context, wherein the first inertial gesture is different from the second inertial gesture.

6. The earpiece of claim 1, wherein:
the audio output comprises at least one audio session with the second device; and
the controller alters the audio output of the directional speaker by, upon failing to detect the gesture by the user associated with an audio session, blocking the transmitting of the audio output of the audio session.

7. The earpiece of claim 1, wherein:
the audio output comprises at least one audio session with the second device; and
the controller alters the audio output of the directional speaker by, upon detecting the gesture by the user associated with an audio session, blocking the transmitting of the audio output of the audio session.

8. The earpiece of claim 7, wherein blocking the transmitting of the audio session further comprises: transmitting to the second device a refusal of the audio session.

9. The earpiece of claim 7, wherein:
the controller, upon detecting a first gesture by the user associated with the audio session, permits the transmitting of the audio output of the audio session; and
the controller, upon detecting a second gesture by the user associated with the audio session, wherein the second gesture is different from the first gesture, blocks the transmitting of the audio output of the audio session.

10. The earpiece of claim 9, wherein:
the second device comprises a communication device;
the audio session comprises a communication session; and
the controller comprising an inertial measurement unit detecting a first inertial head gesture of the user as the first gesture and a second inertial head gesture of the user as the second gesture.

11. The earpiece of claim 1, wherein:
the audio output comprises an audio session with the second device;
upon receiving an offer from the communication second device to initiate the audio session, the earpiece transmits output to the user indicating the offer; and
the controller detects the gesture by the user only while transmitting output to the user indicating the offer.

12. The earpiece of claim 11, wherein:
the controller monitors an environment of the user to detect an offer opportunity to present the offer to the user; and
the directional speaker transmits the output to the user indicating the offer during the offer opportunity.

13. An earpiece wearable by a user and usable with a second device of the user, the earpiece comprising:
a housing mountable on an ear of the user and comprising a directional speaker selectively oriented toward an ear canal of the user;
a receiver that:
receives audio output from the second device through a wireless protocol, and
conducts the audio output received from the second device to the directional speaker; and
a controller that, when upon detecting a gesture by the user, alters the audio output of the directional speaker.

14. The earpiece of claim 13, wherein the controller, upon detecting an interruption of the wireless communication session with the second device, the earpiece transmits output to the user indicating the interruption of the wireless communication session.

15. The earpiece of claim 13, wherein the housing does not obstruct ambient sound arising within an environment of the user.

16. The earpiece of claim 13, wherein the controller:
detects a volume of ambient sound of an environment of the user; and
adjusts a volume level of the audio output of the directional speaker proportionally with the volume of the ambient sound of the environment of the user.

17. The earpiece of claim 13, wherein the controller:
detects a volume of ambient sound of an environment of the user; and
selects a volume level of the audio output of the directional speaker that is substantially inaudible outside of the ear canal of the user over the volume of the ambient sound of the environment.

18. The earpiece of claim 13, wherein:
the earpiece further comprises a processor;
the earpiece further comprises at least one application respectively associated with an application gesture and executable on the processor; and
the controller, upon detecting an application gesture by the user, initiates the application associated with the application gesture on the processor.

19. An earpiece set wearable by a user and usable with a second device of the use, the earpiece set comprising:
at least two housings respectively mountable on an ear of the user;
for at least one housing, at least one receiver that couples wirelessly with the second device to receive audio output from the second device;
for respective housings, a directional speaker positioned on the housing that, when the housing is mounted on the ear of the user, transmits the audio output selectively toward the ear canal; and
for at least one housing, a controller incorporated in the housing that, when upon detecting a gesture by the user, alters the audio output of the directional speaker.

20. The earpiece set of claim 19, wherein:
respective housings further comprise a battery; and
at a particular time, the at least one controller selectively activates the directional speaker of a first housing and deactivates the directional speaker of a second housing.
